(19) United States
(12) Patent Application Publication
(10) Pub. No.: US 2016/0019517 A1
(43) Pub. Date: Jan. 21, 2016

(54) METHODS AND DEVICES FOR ALLOWING CONSUMER ACCESS TO DETAILED FINANCIAL TRANSACTIONAL DATA

(71) Applicants: AMIR KIRSH, Zafaria (IL); AVRAHAM ROTH, Givat Shmuel (IL)

(72) Inventors: AMIR KIRSH, Zafaria (IL); AVRAHAM ROTH, Givat Shmuel (IL)

(21) Appl. No.: 14/333,520

(22) Filed: Jul. 17, 2014

(51) Int. Cl. G06Q 20/20; G07G 1/12; G07G 1/14; G07G 5/00

(52) U.S. Cl. CPC G06Q 20/209; G07G 5/00; G07G 1/12; G07G 1/14

(57) ABSTRACT

The invention discloses devices and methods for converting purchase details from paper to digital receipts. In some embodiments, receipts may include a code that may be read specifically by a smartphone or similar device uniquely identified with a predetermined user. Scanned receipts allow access to detailed purchase information which in some embodiments can be combined and analyzed to allow for most cost efficient buying.

### FIELD AND BACKGROUND OF THE INVENTION

The present invention, in some embodiments thereof, relates to methods and devices for allowing a consumer greater access to his/her credit card data. The instant invention, in some embodiments, allows for storing aggregate data relating to credit card transactions and letting a consumer with a smartphone access to said data.

Two of the most powerful developments in the past fifty years have been credit cards and smartphones. Credit cards have allowed for trillions of dollars worth of purchases at stores and websites throughout the world. Without credit cards, world economies could not grow at the rates they presently enjoy and consumers would be much more limited in their options for making purchases, with online purchases especially hampered. Smartphones, similarly, have given their users unparalleled computing power and technical tools in their pockets. A standard smartphone includes a multi-touch screen, GPS, an HD video camera, music player, video player, and of course, a cellular phone. Smartphones have revolutionized the way people communicate and organize their lifestyles. Waze aids in GPS navigation, while FaceTime and Skype allow video calls that were once the exclusive purview of the very rich.

While billions of credit card transactions take place every month, a consumer generally has antiquated means of following his/her transaction history. In the vast majority of cases, a holder of a credit card receives once monthly—either by mail or by email—a summary of card use for the previous month. A typical consumer will have dozens or purchases from a wide range of goods and services providers. Most individuals do not remember each purchase and the actual charge taken at the cash register. Additionally, most credit card summaries do not give an individual breakout of the overall payment. That information is generally found on a store receipt; as the number of receipts in one's wallet or back pocket grows, the ability to keep accurate information on purchases and their details declines. The number of consumers who compare each receipt with a line in a credit card statement is relatively small, in part due to the requirement to keep all receipts in an orderly manner And if one uses multiple credit cards, the ability to figure out which bill comes from which card for what period of charge becomes even more complex.

Smartphones, with their cameras, fast processors, Internet access, and large memories, are ideally suited for providing better control and understanding of credit card data. Ideally, as a smartphone is associated with a unique phone number as individual as a credit card number, one could use a smartphone to specifically arrange, organize, and analyze credit card data, with no requirement for monthly statements or the manual checking of physical cash register receipts.

International Patent Application No. PCT/EP2013/070603 to Belpaire & Natu describes a cloud based payment method for payment at a merchant's electronic cash register (202) comprising the steps of: A. registering payment credentials (101) of a user; —at check-in of a store of a participating merchant: B1. launching a cloud payment application (211) on a mobile terminal (201) to establish connectivity with a cloud payment service (100); —and at check-out at an electronic cash register (202): C1. identifying (221, 222; 321, 323) the user with the cloud payment service (100) through an identification shared with the cloud payment service (100) via the electronic cash register (202) or via the cloud payment application (211); C2. communicating (222; 322) an amount payable from the electronic cash register (202) to the cloud payment service (100); C3. communicating (223; 324) the amount payable from the cloud payment service (100) to the cloud payment application (211); C4. receiving (224; 325) confirmation of the amount payable from the user; C5. obtaining (225; 326) payment authorization using the payment credentials (101); and C6. confirming (226; 327) payment from the cloud payment service (100) to the electronic cash register (202).

U.S. patent application Ser. No. 12/807,438 to Krampe teaches a method for paying for a product or service in a cash register with a credit card using a personal wireless communication device. The method includes loading vending universal wireless interface software into a cash register to interface with the case register microprocessor and an RF transceiver to control communication between the cash register and the personal wireless communication device so that the personal communication device can obtain transaction data from the cash register and communicate the data to a remote server for credit card approval for payment of the transaction so that the transaction can be executed by the cash register.

U.S. patent application Ser. No. 13/698,773 to Sulaiman, et al. describes a receipt system that allows customers to store receipts on a Unified Card or smartphone when making purchases from different retailer merchants. The customer purchases goods or services and the receipt is recorded electronically onto a single Unified Card or smartphone. This eliminates the need for paper receipts. The user can then use the Unified Card or smartphone to make returns or exchanges or as proof of purchase. Unified Card readers can be located at Kiosks as part of a home based system that works with the user's home computer.

U.S. patent application Ser. No. 14/021,900 to Dismukes, et al. teaches a system providing a two device solution for transaction processing, a merchant facing device (MFD) and a cardholder (customer) facing device CFD. What this means is that one device always faces the checkout representative of the merchant (the merchant facing device) and the other faces the consumer (the cardholder facing device). The CFD includes a payment/card reader (such as a swipe style reader, a near field communication (NFC) or RFID reader, or some other contactless means) and a numeric key pad (i.e. PIN pad) where the consumer can, when required, allow the card to be read (e.g. by swipe, insert, or wave the card) and enter an authorization PIN (personal identification number).

### SUMMARY OF THE INVENTION

It is therefore a purpose of the present invention, in some embodiments, to describe methods and devices for allowing digital collection of purchase data associated with a credit card or other means of purchase. In some embodiments of the invention, a physical purchase receipt may include information that allows for retrieving detailed purchase data via a mobile computing device.

The invention includes a device for allowing access to details of a purchase, including: at least one cash register adapted to store details of a purchase; a receipt generated by the cash register for the purchase, the receipt adapted to include a code identifying the purchase; and, a mobile computing device with a graphical user interface adapted to scan the code and access some or all of the details related to the purchase.

In one aspect of the device, the cash register is realized as a plurality of cash registers and the purchase is realized as a plurality of purchases.

In another aspect of the device, the mobile computing device is realized as a smartphone, a cellular phone, a tablet computer, a wearable computing device, a watch computing device, Google Glass, a laptop computer, or a mobile electronic device.

In another aspect of the device, the details include date of purchase, time of purchase, location of purchase, cash register number, last four digits of credit/debit card if employed in payment, amount paid, items purchased, unit price per item, number of each item purchased, any discounts for any of the items, and any coupons employed in the purchase.

In another aspect of the device, the cash register is further adapted to send the details of the purchase to at least one predetermined server.

In another aspect of the device, the code allows access of the details of the purchase on the at least one predetermined server.

In another aspect of the device, the receipt is realized as a digital receipt adapted to be sent wirelessly from the cash register to the mobile computing device.

In another aspect of the device, the details are accessible to producers of the items purchased.

The invention includes a method for providing digital details of a purchase to a consumer, including: providing a cash register adapted to send predetermined details relating to a purchase to at least one predetermined server; performing a check-out with the cash register, wherein a consumer pays at the cash register for at least one item that he/she has purchased; sending details of the purchase to the at least one predetermined server; providing the consumer with a paper receipt of the purchase, the receipt including at least one code adapted to allow the consumer access to the details of the purchase from the at least one predetermined server; scanning the code on the receipt with a mobile computing device; accessing the details of the purchase on the mobile computing device; and, displaying on a graphical user interface associated with the mobile computing device the details of the purchase.

In one aspect of the method, the at least one server is associated with a cloud-based computing system.

In another aspect of the method, the at least one server is associated with a client-server network.

In another aspect of the method, there is additionally a step of sending the details wirelessly from the cash register to the mobile computing device.

In another aspect of the method, the checkout involves payment with a credit/debit card.

In another aspect of the method, the details include date of purchase, time of purchase, location of purchase, cash register number, last four digits of credit card if employed in payment, amount paid, items purchased, unit price per item, number of each item purchased, any discounts for any of the items, and any coupons employed in the purchase.

In one aspect of the method, the details further include a warranty for at least one item purchased.

In another aspect of the method, there is an additional step of sending the details to at least one third parties.

In another aspect of the method, the at least one third party is a manufacturer of at least one item involved in the checkout.

The invention additionally includes a device for allowing access to details of a purchase, including: a cash register; a wireless communication module associated with the cash register; and, a mobile computing device adapted to receive information from the cash register via said wireless communication module.

In one aspect of the device, the wireless communication module is realized as a cellular network, WiFi, IR, Bluetooth, RF, RFID, NFC, SMS, MMS, IP Push, sound signals or communication over application API.

In another aspect of the device, the information may include any of the following: date of purchase, time of purchase, location of purchase, cash register number, last four digits of credit card if employed in payment, amount paid, items purchased, unit price per item, number of each item purchased, any discounts for any of said items, and any coupons employed in said purchase.

Unless otherwise defined here or in the embodiments, all technical and/or scientific terms used herein may have their same meaning as commonly understood by one of ordinary skill in the art to which the term pertains.

A “cash register” may refer to any device, system, or element that is adapted, at least in part, to perform a financial transaction. Non-limiting examples include traditional cash registers found at checkouts of stores, ATM's, gas pumps adapted to record credit card or other transactions, self-checkout systems, hand-portable credit card processing devices, online payment systems, and the like. A cash register may generate a physical or virtual receipt. A cash register may temporarily or permanently store transactional data and may be adapted to send such data to another device such as a server or mobile computing device. A cash register may include any of its components such as but not limited to front end components, back office components such as store servers, regional servers, retailer's servers, cashier manufacturer servers and the like. A point of sale (POS) may be considered a cash register for the instant invention.

“Mean(s) of payment” may include without limitation any of the following: checks, credit cards, debit cards, pre-paid cards, travelers checks, bitcoin, money transitions, cash, wire transfer, clearing house services (such as PayPal), electronic wallet, payments through cellular account, gift certificates, bonus points, parking account or any other accounts such as electricity account, and the like.

A “credit card” may refer to a credit card, debit card, PayPal, bank transfer protocol, wire transfer, check or other payment element adapted to allow a transfer of funds from a defined individual or group (unlike say, cash) in exchange for goods, services, or the like.

“Server”, “cloud” and “cloud computing” may have their generally understood meaning in the Internet arts. A “receipt” may be digital, physical, virtual, or paper-based.

A “mobile computing device” may generally refer to a device or element adapted to perform computational actions. Non-limiting examples of a mobile computing device include smartphones, hand-held computers, Google Glass, smart watches, tablet computers, laptop computers, and the like.

A “smartphone” may have its generally understood meaning.

A “code” may generally refer to a symbol, picture, barcode, QR code, or the like adapted to be scanned by a smartphone camera, digital camera or similar device. A code may further be adapted to be interpreted by an application (app) or program associated with a mobile computing device. A code generally includes information on a purchase performed by an owner of a mobile computing device.

A credit/debit card or means of payment “provider” may generally be realized as a bank, financial institution, credit union or other body that provides a credit/debit card or similar instrument adapted to allow for purchases with said credit/debit card or similar instrument. A bank that issues credit cards is a non-limiting example of a provider according to some embodiments of the instant invention.

“Validity” may generally mean that a given transaction or plurality of transactions has actually taken place.

“Communication mean(s)” may refer to wired or wireless communication between a cash register and a computing device may generally be realized as cellular network, WiFi, IR, Bluetooth, RF, RFID, NFC, SMS, MMS, IP Push, sound signals or communication over application API.

A “commercial transaction” may generally refer to any action whereby a first party pays a second party for a service, item and/or good owned by or belonging to second party. Cash payments, credit card and debit card payments for goods and services, wire transfers for payment and bartering are non-limiting examples of commercial transactions.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100. Several black-and-white photographs have been incorporated into the Figures as they add to the understanding of the instant invention.

In the drawings:

FIG. 1 shows a flowchart of a method associated with an embodiment of the instant invention;

FIGS. 2A-2F show schematic views of arrangements of elements according to the method of FIG. 1;

FIGS. 3-5 show schematic views of embodiments of the instant invention;

FIGS. 6A-6G show non-limiting examples of mobile computing devices;

FIG. 7 shows an additional embodiment of the instant invention;

FIGS. 8A-8B show an additional embodiment of the instant invention; and,

FIG. 9 shows a schematic view of an additional embodiment of the invention.

### DESCRIPTION OF SPECIFIC EMBODIMENTS OF THE INVENTION

The present invention, in some embodiments thereof, relates to methods and devices for making more efficient use of credit card and other purchase data.

The instant invention, in some embodiments, addresses an important issue in a rapidly expanding market. In the past, credit cards represented one of several—cash, checks, bank transfers—means to pay for transactions. In today's economy, credit cards are often the only way to pay for certain goods or services. Gas pumps often require credit card activation prior to pumping gas. Many bills or vending machines are adapted to use credit cards for rapid transactions. As such, credit card use is growing enormously, with the average American holding several different credit cards, often from different card providers.

While credit card use is growing enormously, credit card purchase data are still handled as they were circa 1950. Most credit card holders receive a once-monthly statement that gives the absolute minimum of information: date of transaction, vendor, and amount. The details of the purchase and the specific costs of items bought are generally not included in standard credit card statements. This loss of information is significant. At the most basic level, knowing what one has bought would allow for confirming that a purchase was correct. Additionally, if a consumer had detailed access to all of his purchases from one or more credit cards, he could use appropriate software tools to analyze the cost of the items he buys, where prices are best, and what his purchase habits are. He might be shocked to discover that he buys Coca-Cola on average twice a week, but he is paying 30% more when he buys from store X rather than when he buys from the equally accessible store Y.

A credit card has several unique aspects to it: it is associated with a single individual (or company), has a unique identifier in its number, and it gives its users certain capabilities. A more recent device that has several similar properties is the cellular phone in general and the smartphone in particular. A smartphone is generally associated with a single individual, it has a unique (telephone) number that, like a credit card number, is not reproduced for anyone else, and a smartphone also gives its user certain capabilities. Whereas a credit card effectively allows a person to leave his/her house without a penny in his/her pocket, yet still feel safe that anything needed can be bought, a smartphone guarantees its user communication via calls, SMS, email and other means as per needs wherever he/she may be. The instant invention does not necessarily relate to “digital wallet” systems; rather, the instant invention—in some embodiments—describes a functional interaction between credit cards and smartphones.

A smartphone, being almost always available to its user, having a unique identifier, and generally being on a person, just as a credit card is generally in one's wallet, is perfectly situated to make credit card use more efficient and quantitative. Should a credit card user perform a transaction with his/her card, his/her immediately accessible smartphone may be adapted to receive, store, organize, and transfer data on the purchase. As such, while a user is still at the check-out, he/she may be able to access details of the purchase that 1) obviate the need for the once-monthly credit card statement and 2) allow greater detail regarding each purchase.

In the embodiments and discussion below, methods and devices are described for the more efficient and financially prudent use of credit cards and smartphones to give a user a much broader picture of his/her buying habits.

### First Embodiment

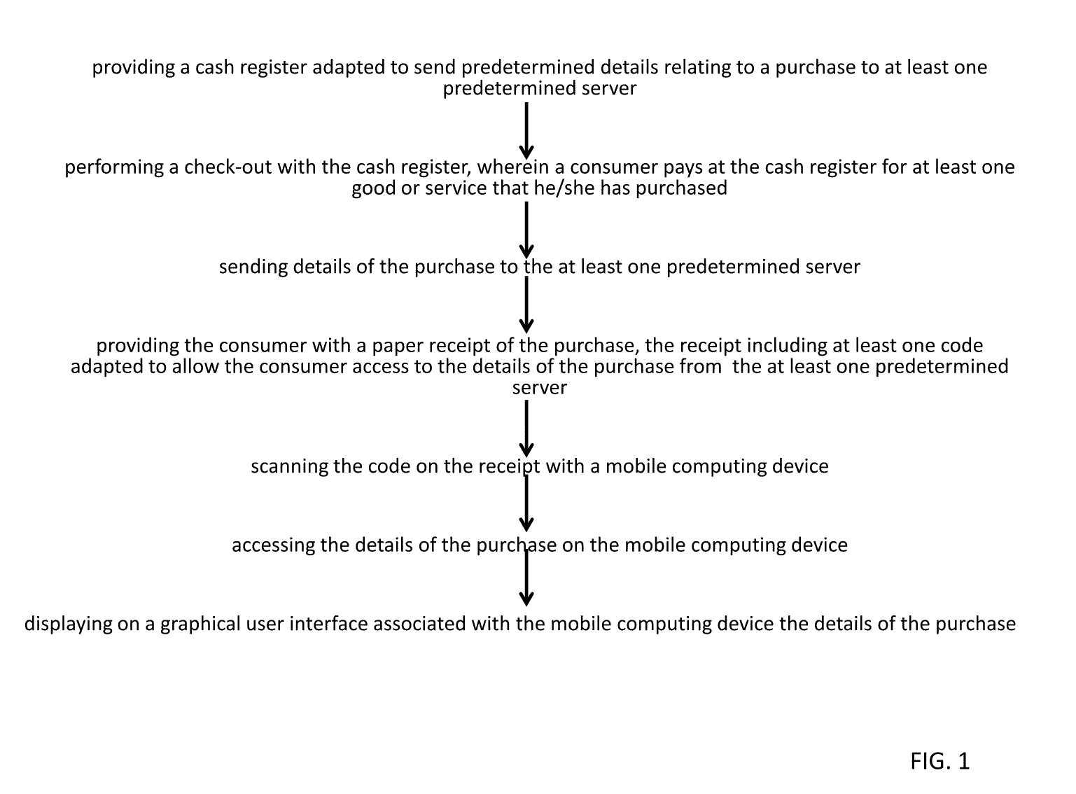

Attention is turned to FIG. 1, which shows a flowchart of a method associated with an embodiment of the instant invention. The invention includes a method for providing digital details of a purchase to a consumer, including: providing a cash register adapted to send predetermined details relating to a purchase to at least one predetermined server; performing a check-out with the cash register, wherein a consumer pays at the cash register for at least one item that he/she has purchased; sending details of the purchase to the at least one predetermined server; providing the consumer with a paper receipt of the purchase, the receipt including at least one code adapted to allow the consumer access to the details of the purchase from the at least one predetermined server; scanning the code on the receipt with a mobile computing device; accessing the details of the purchase on the mobile computing device; and, displaying on a graphical user interface associated with the mobile computing device the details of the purchase.

In one aspect of the method, the at least one server is associated with a cloud-based computing system. In another aspect of the method, the at least one server is associated with a client-server network. In another aspect of the method, there is additionally a step of sending the details wirelessly from the cash register to the mobile computing device. In another aspect of the method, the checkout involves payment with a credit/debit card. In another aspect of the method, the details include date of purchase, time of purchase, location of purchase, cash register number, last four digits of credit card if employed in payment, amount paid, items purchased, unit price per item, number of each item purchased, any discounts for any of the items, and any coupons employed in the purchase. In one aspect of the method, the details further include a warranty for at least one item purchased. In another aspect of the method, there is an additional step of sending the details to at least one third parties. In another aspect of the method, the at least one third party is a manufacturer of at least one item in the purchase.

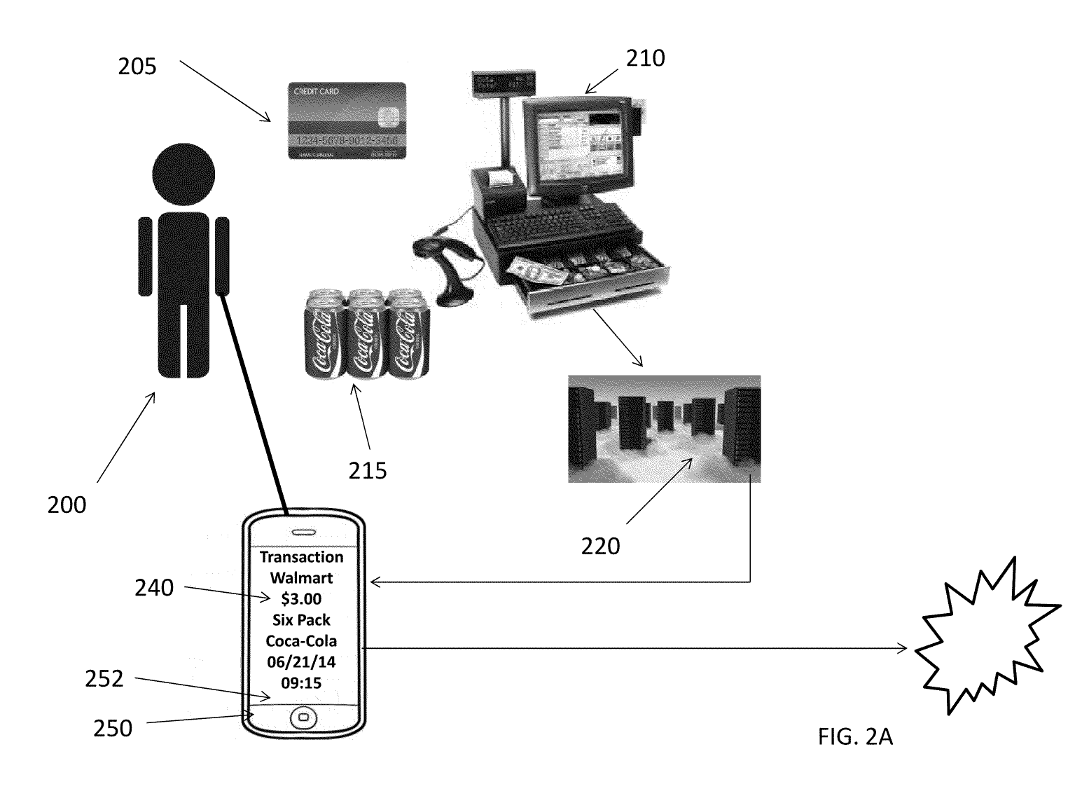

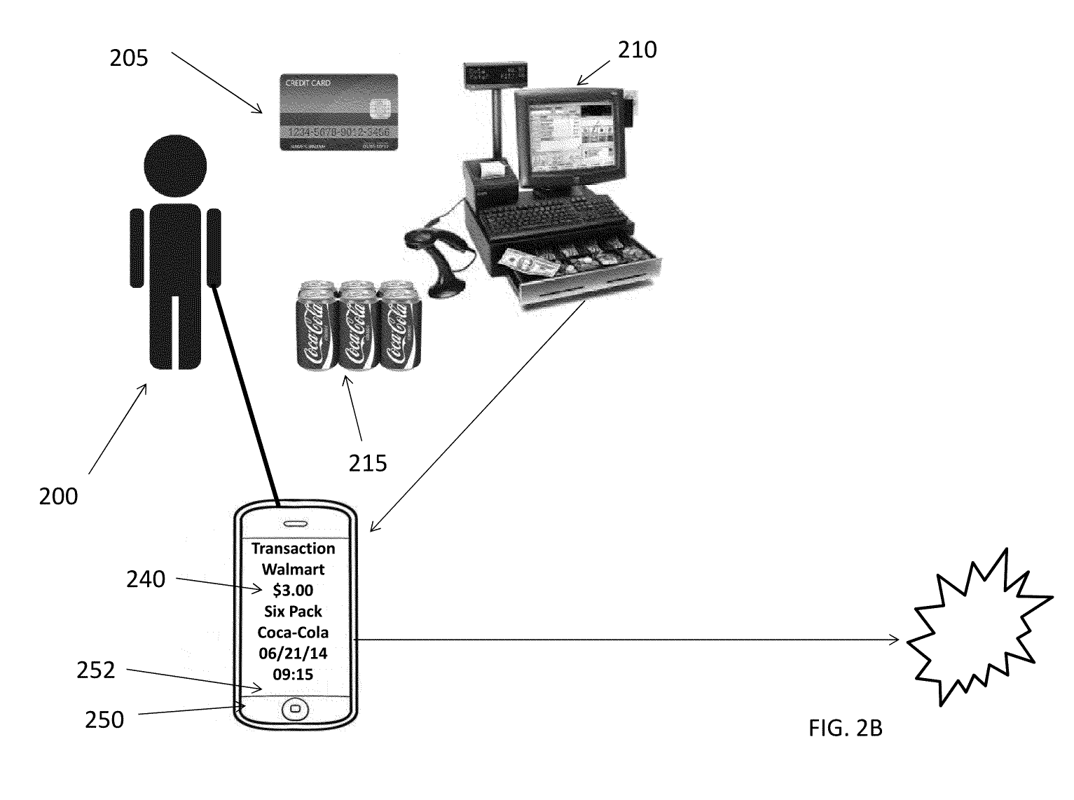

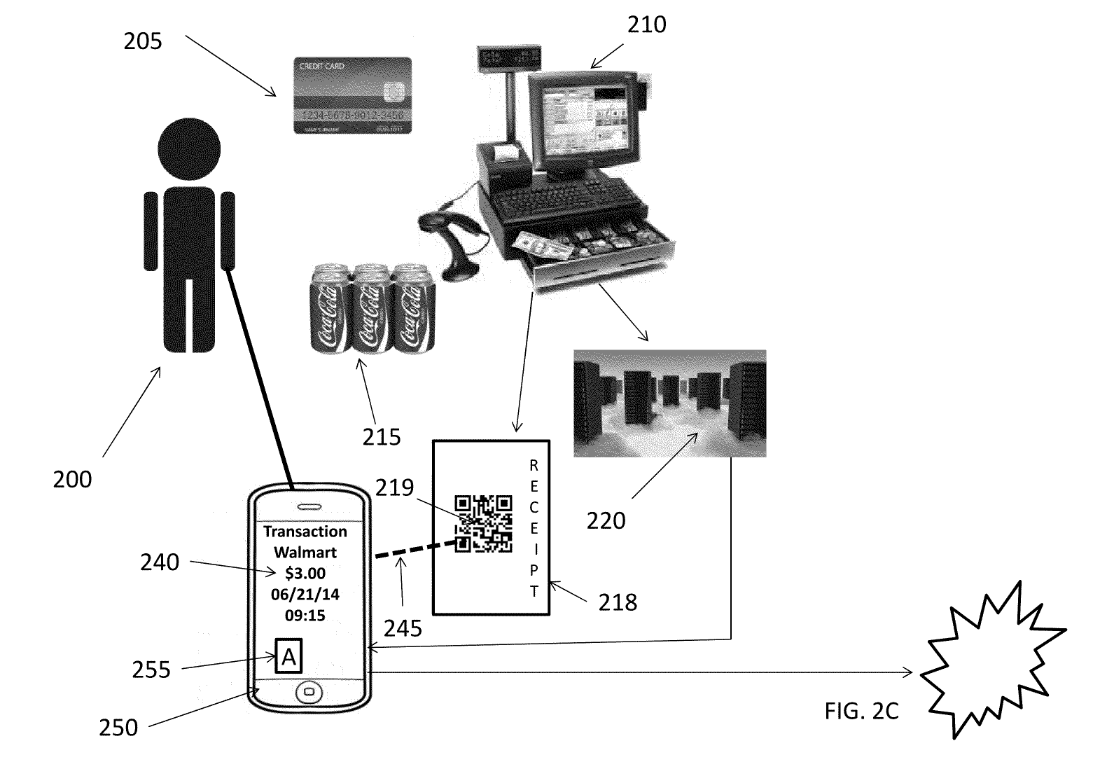

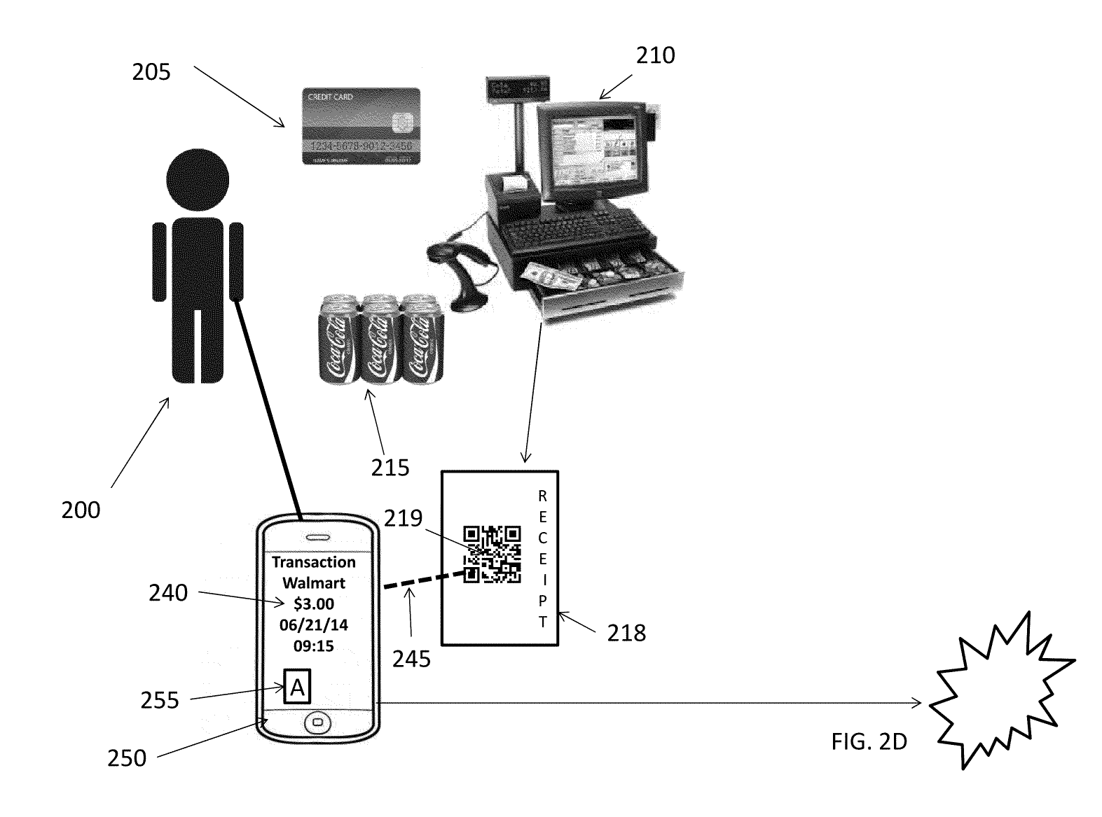

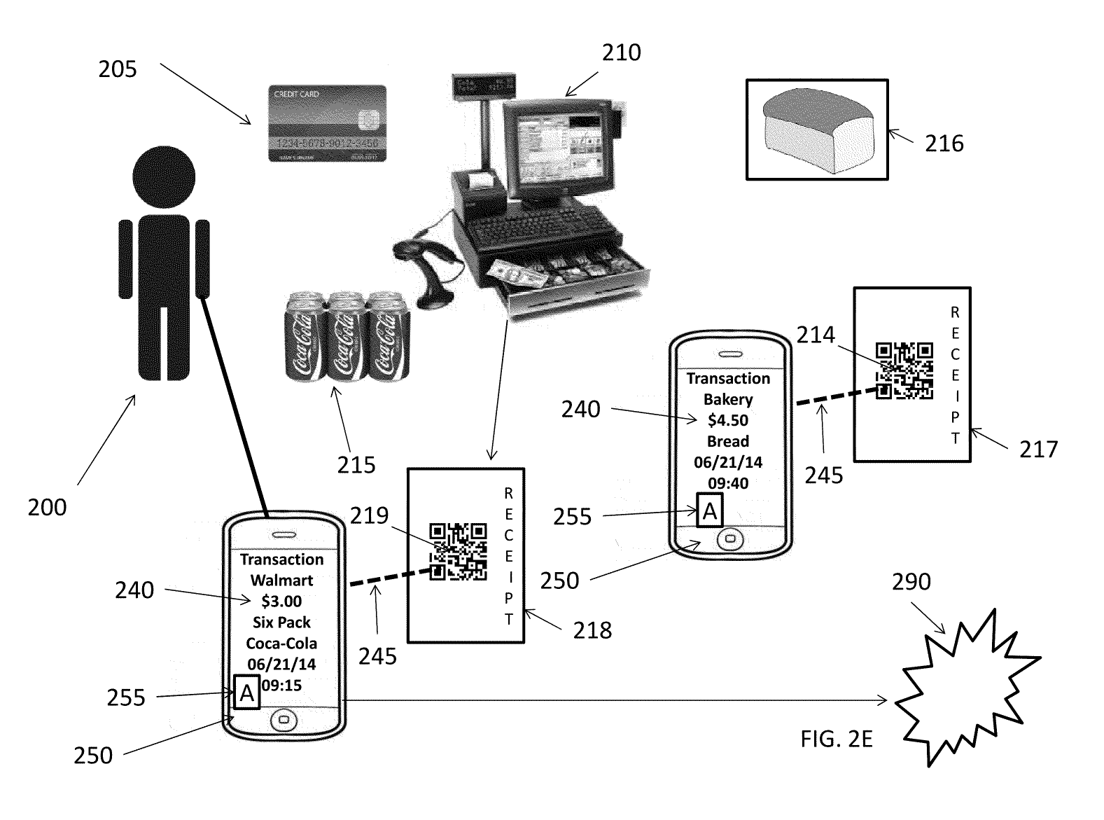

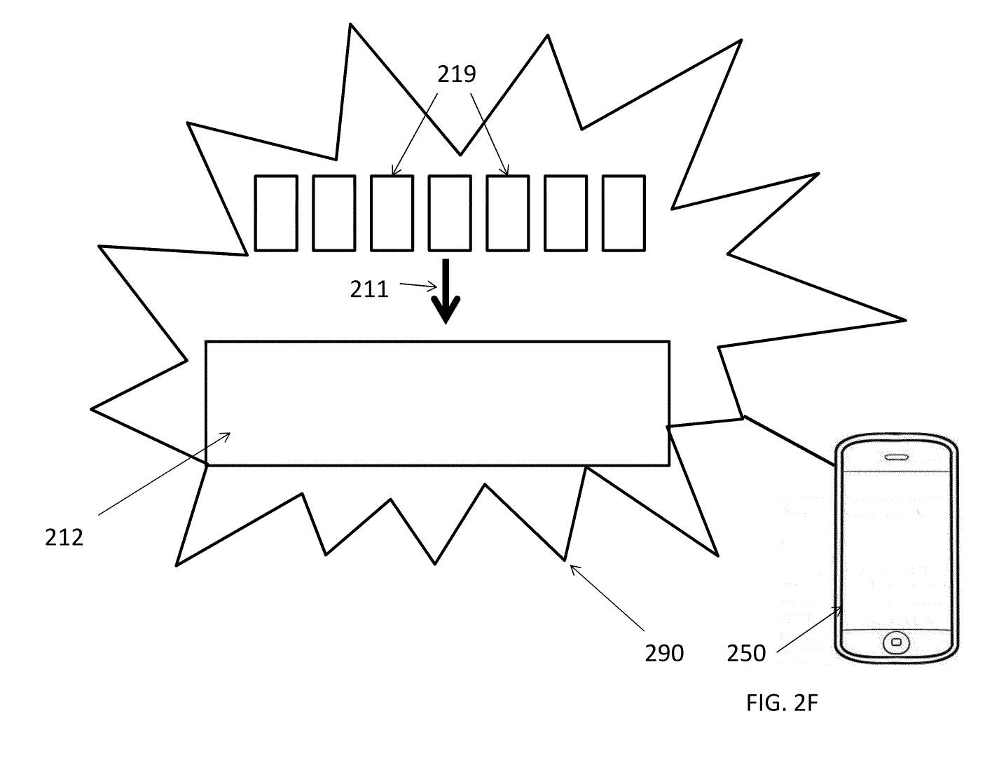

In many instances, the mobile computing device is realized as a smartphone. FIG. 2A provides a schematic view of elements of the instant method. A user 200 makes a purchase of a good or service 215 via a cash register 210. The good or service 215 can be any good or service, without restriction. A credit card 205 or other payment element such as cash, check, traveler's check, wire transfer, PayPal, loan, or the like may be used to effect the payment for good or service 215. The cash register 210 may be any device, machine, or element adapted to execute a transaction in which money or a money equivalent (including bartering) is proffered for a good, item or service. The cash register 210 may be an element that is part of another machine. The cash register 210 may be adapted to send details of the purchase to a server 220, Cloud-based system, network, VPN, intranet, or other data storage system. The server 220 or other data storage system may be adapted to send details, which may include—for example—the last four digits of a credit card 205 employed in the transaction, date and time of transaction, location of transaction cash register 210 identifier, and checkout clerk number. The server 220 may send the data automatically to a smartphone 250 or other mobile computing device associated uniquely with the owner of the credit card 205 or other payment element. Details 240 of the purchase may optionally be displayed on a graphical user interface 252 associated with the smartphone 250. Alternatively or additionally, the smartphone 250, possibly via an associated application, may send some or all of the details 240 to a storage system 290. The storage system 290 is generally adapted to hold a plurality of details 240 of all or some transactions associated with credit card 205 as well as optionally other credit cards or other means of payment.

FIG. 2B provides a schematic view of elements of the instant method. A user 200 makes a purchase of a good or service 215 via a cash register 210. The good or service 215 can be any good or service, without restriction. A credit card 205 or other payment element such as cash, check, traveler's check, wire transfer, PayPal, loan, or the like may be used to effect the payment for good or service 215. The cash register 210 may be any device, machine, or element adapted to execute a transaction in which money or a money equivalent (including bartering) is proffered for a good, item or service. The cash register 210 may be an element that is part of another machine. The cash register 210 may be adapted to send details, which may include—for example—the last four digits of a credit card 205 employed in the transaction, date and time of transaction, location of transaction cash register 210 identifier, and checkout clerk number to a smartphone 250 or other mobile computing device uniquely associated with user 200. The cash register 210 may send the details automatically to a smartphone 250 or may require prompting by user 200 and his/her smartphone 250. Details 240 of the purchase may optionally be displayed on a graphical user interface 252 associated with the smartphone 250. Alternatively or additionally, the smartphone 250, possibly via an associated application, may send some or all of the details 240 to a storage system 290. The storage system 290 is generally adapted to hold a plurality of details 240 of all or some transactions associated with credit card 205 as well as optionally other credit cards or other means of payment.

FIG. 2C provides an additional schematic view of elements of the instant method. A user 200 makes a purchase of a good or service 215 via a cash register 210. The good or service 215 can be any good or service, without restriction. A credit card 205 or other payment element such as cash, check, traveler's check, wire transfer, PayPal, loan, or the like may be used to effect the payment for good or service 215. The cash register 210 may be any device, machine, or element adapted to execute a transaction in which money or a money equivalent (including bartering) is proffered for a good, item or service. The cash register 210 may be an element that is part of another machine. The cash register 210 may be adapted to send details of the purchase to a server 220, Cloud-based system, network, VPN, intranet, or other data storage system. The cash register 210 may also be adapted to produce a physical receipt 218 that may include a code 219 that may be uniquely scanned and interpreted by a smartphone 250 linked to user 200 via a unique phone number or other identifier associated with the smartphone 250. The server 220 or other data storage system may be adapted to send details, which may include—for example—the last four digits of a credit card 205 employed in the transaction, date and time of transaction, location of transaction cash register 210 identifier, and checkout clerk number to smartphone 250, when prompted by smartphone 250 after scanning 245 of the code 219 by a smartphone 250 camera (not visible). An app 255 may direct the request for data from the server 220 or in some cases from the cash register 210 itself. Details 240 of the purchase may optionally be displayed on a graphical user interface 252 associated with the smartphone 250. Alternatively or additionally, the smartphone 250, possibly via an associated application, may send some or all of the details 240 to a storage system 290. The storage system 290 is generally adapted to hold a plurality of details 240 of all or some transactions associated with credit card 205 as well as optionally other credit cards or other means of payment.

FIG. 2D provides an additional schematic view of elements of the instant method. A user 200 makes a purchase of a good or service 215 via a cash register 210. The good or service 215 can be any good or service, without restriction. A credit card 205 or other payment element such as cash, check, traveler's check, wire transfer, PayPal, loan, or the like may be used to effect the payment for good or service 215. The cash register 210 may be any device, machine, or element adapted to execute a transaction in which money or a money equivalent (including bartering) is proffered for a good, item or service. The cash register 210 may be an element that is part of another machine. The cash register 210 may be adapted to produce a physical receipt 218 that may include a code 219 that may be uniquely scanned and interpreted by a smartphone 250 linked to user 200 via the unique phone number associated with the smartphone 250. The code 219 may include purchase details, which may include—for example—the last four digits of a credit card 205 employed in the transaction, date and time of transaction, location of transaction cash register 210 identifier, and checkout clerk number. The smartphone 250 is adapted to scan 245 the QR or other code 219 and enter said purchase details into a memory of the smartphone 250. An app 255 associated with smartphone 250 may allow for details 240 of the purchase to be optionally displayed on a graphical user interface 252 associated with the smartphone 250. Alternatively or additionally, the smartphone 250, possibly via an associated application, may send some or all of the details 240 to a storage system 290. The storage system 290 is generally adapted to hold a plurality of details 240 of all or some transactions associated with credit card 205 as well as optionally other credit cards or other means of payment.

FIG. 2E provides an additional schematic view of elements of the instant method. A user 200 makes a purchase of a good or service 215 via a cash register 210. The good or service 215 can be any good or service, without restriction. A credit card 205 or other payment element such as cash, check, traveler's check, wire transfer, PayPal, loan, or the like may be used to effect the payment for good or service 215. The cash register 210 may be any device, machine, or element adapted to execute a transaction in which money or a money equivalent (including bartering) is proffered for a good, item or service. The cash register 210 may be an element that is part of another machine. The cash register 210 may be adapted to produce a physical receipt 218 that may include a code 219 that may be uniquely scanned and interpreted by a smartphone 250 linked to user 200 via the unique phone number associated with the smartphone 250. The code 219 may include purchase details, which may include—for example—the last four digits of a credit card 205 employed in the transaction, date and time of transaction, location of transaction cash register 210 identifier, and checkout clerk number. The smartphone 250 is adapted to scan 245 the QR or other code 219 and enter said purchase details into a memory of the smartphone 250. An app 255 associated with smartphone 250 may allow for details 240 of the purchase to be optionally displayed on a graphical user interface 252 associated with the smartphone 250. Alternatively or additionally, the smartphone 250, possibly via an associated application, may send some or all of the details 240 to a storage system 290. User 200 may make a second purchase of a good or service 216 with the same credit card 205 or different credit card or payment intermediary. A second receipt 217 may be generated with a unique QR or other code 214 that allows for scanning by smartphone 250 and storage and optional presentation of data on smartphone touch screen. The storage system 290 is generally adapted to hold a plurality of details 240 of all or some transactions associated with credit card 205 as well as optionally other credit cards or other means of payment. The storage system 290 is adapted to receive details of purchase of good or service 215 as well as good or service 216. Note that two unique receipts 218 & 217 are show in FIG. 2E, while the smartphone 250 is one and the same and is only shown twice so as to allow for viewing of different data on its screen, as shown.

Attention is turned to FIG. 2F. A smartphone 250 has wireless access to a transaction data storage system 290. In the data storage system may be stored a plurality of receipts 219 based on purchases made by the owner of the smartphone. The receipts 219 may be associated with all transactions performed by the owner of the smartphone or it may be limited to a single or plurality of credit/debit cards. The data storage system 290 may be adapted to hold receipts or purchase data from relatives or associates of the owner of the smartphone 250; for example, the data storage system 290 may hold all receipts of a husband and wife, even though the data storage system 290 is explicitly associated with the smartphone 250 of the husband. Alternatively or additionally, multiple smartphones may have access to the same transaction data system 290. The data in the receipts 219 may optionally be organized 211 in a chart 212 or a plurality of charts. Items purchased may be organized by barcode, date of purchase, location of purchase, manufacturer, price, or other features. If several of the receipts 219 include purchase of the same item (as determined by barcode), then the multiple purchases may be grouped to allow user to see when he/she bought that item, where, with what frequency and at what price range. Organization of data allows for greater control of purchasing and identification of optimal prices, something that is very difficult to do with a plurality of paper receipts from various stores and vendors.

### Second Embodiment

The invention includes a device for allowing access to details of a purchase, including: at least one cash register adapted to store details of a purchase; a receipt generated by the cash register for the purchase, the receipt adapted to include a code identifying the purchase; and, a mobile computing device with a graphical user interface adapted to scan the code and access some or all of the details related to the purchase.

In one aspect of the device, the cash register is realized as a plurality of cash registers and the purchase is realized as a plurality of purchases. In another aspect of the device, the mobile computing device is realized as a smartphone, a cellular phone, a tablet computer, a wearable computing device, a watch computing device, Google Glass, a laptop computer, or a mobile electronic device. In another aspect of the device, the details include date of purchase, time of purchase, location of purchase, cash register number, last four digits of credit/debit card if employed in payment, amount paid, items purchased, unit price per item, number of each item purchased, any discounts for any of the items, and any coupons employed in the purchase. In another aspect of the device, the cash register is further adapted to send the details of the purchase to a at least one predetermined server. In another aspect of the device, the code allows access of the details of the purchase on the at least one predetermined server. In another aspect of the device, the receipt is realized as a digital receipt adapted to be sent wirelessly from the cash register to the mobile computing device. In another aspect of the device, the details are accessible to producers of the items purchased.

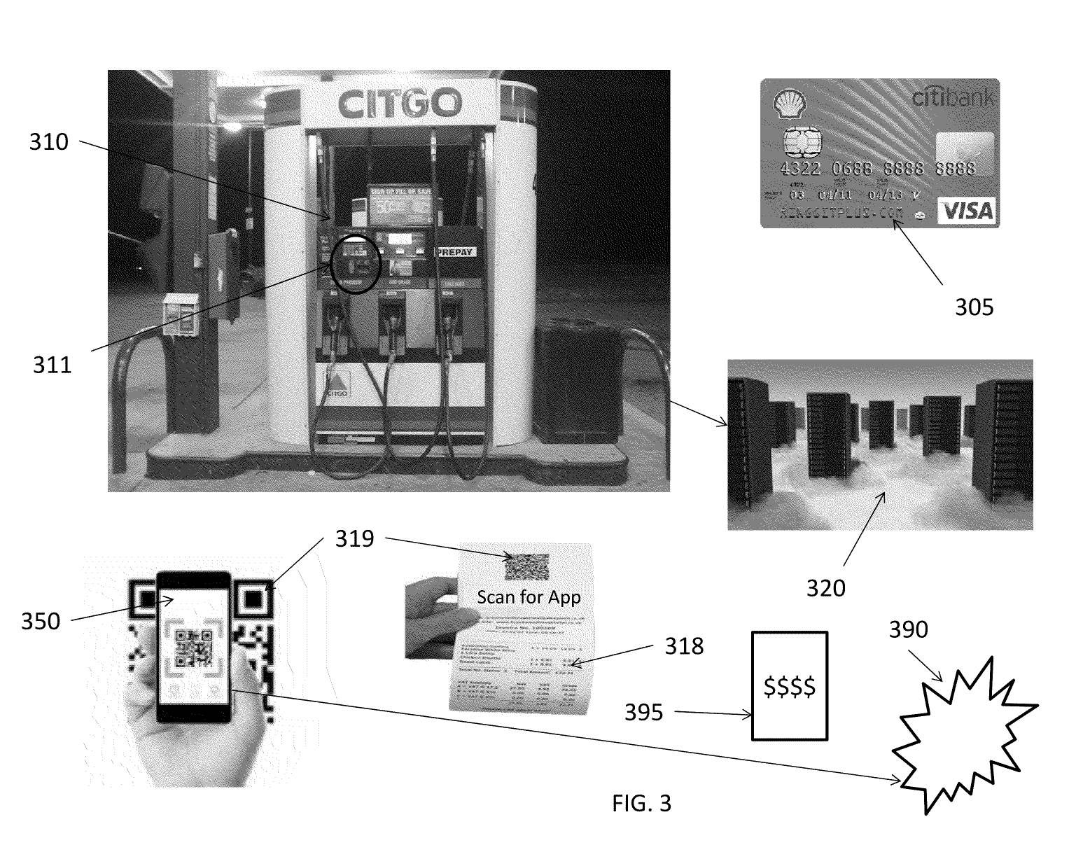

The instant embodiment includes elements that allow for a user to receive both a physical receipt of a purchase as well as a digital version that may be further stored and/or manipulated by a user. Attention is turned to FIG. 3. A user (not shown) has a credit card 305 adapted to be placed in a dedicated reader 311 of a cash register 310 associated with a gas pump. User buys gas and receives a paper receipt 318 that includes a code 319 adapted to be scanned by a smartphone 350 or similar mobile computing device. Scanning of code 319 may lead to smartphone 350 recording of details related to purchase and/or access to memory of the cash register 310 or an associated data network 320 to receive details regarding the purchase. The cash register 310 is optionally adapted to send data about the gas purchase, including the last four digits of the credit card 305, the date, the cost of the purchase, the location of the purchase and the pump number, to a cloud-based or other network 320. The smartphone 350 receives data either directly from the code 319 of the receipt 318 or from the cash register 310 or from associated network 320 via accessing the code 319 of the receipt 318. The data may be stored in the smartphone 350 and/or passed along to a dedicated storage site 390 as described in the previous embodiment. Coupons 395 or discounts may be displayed on the physical receipt 318 and the receipt that appears on the screen of the smartphone 350.

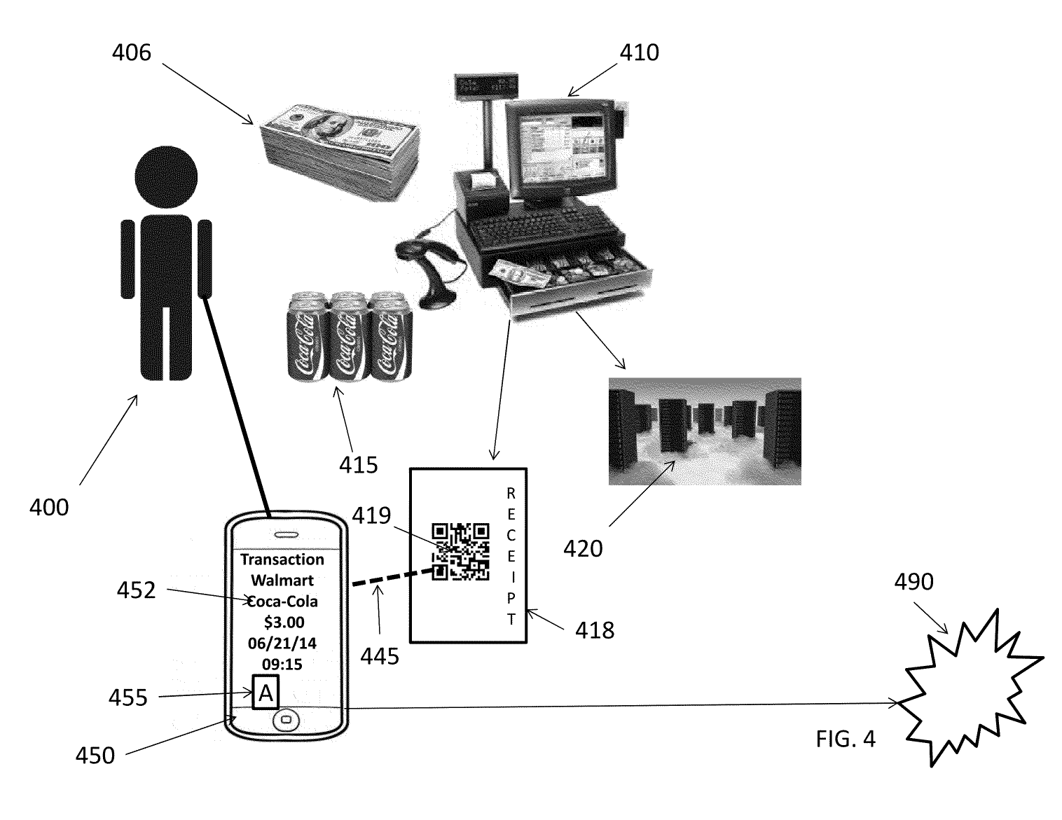

The instant embodiment may also be applied to non-credit card payments. Attention is turned to FIG. 4. A user 400 makes a purchase of a service or item 415 and pays with cash 406 or other payment instrument such as PayPal, check, wire transfer or the like. The cash register 410 handling the transaction produces a physical receipt 418 which includes a code 419 adapted to be read by user 400 smartphone 450 only (the user 400 having given his/her telephone number to a clerk at the cash register 410, or alternatively, the transaction includes the smartphone 450 telephone number data). The smartphone 450 scans 445 the code 419 on the receipt 418, and on the smartphone 450 graphical user display 452 optionally appears details of the purchase: what service or item 415 was purchased, how much money 406 was tendered and how much change was given. Additional details such as date and time, cash register 410 number and clerk identifier may also be provided. Details (data) of the purchase may be retrieved directly from the receipt 418 via the code 419, or through the cash register 410 or an associated network 420, again via the code 419 that is only accessible via the user's smartphone 450. The data associated with the purchase of the item 415 may be combined and/or compared with other purchases to allow user 400 to keep accurate track of her purchases and how her money 406 is used. An application 455 may be included with the smartphone 450 to allow for organizing and analyzing purchase data as that provided by the scanned receipt 418. Data may optionally be sent by the smartphone 450 to a memory storage device, computer or network 490 for long-term or short-term storage and user 400 access.

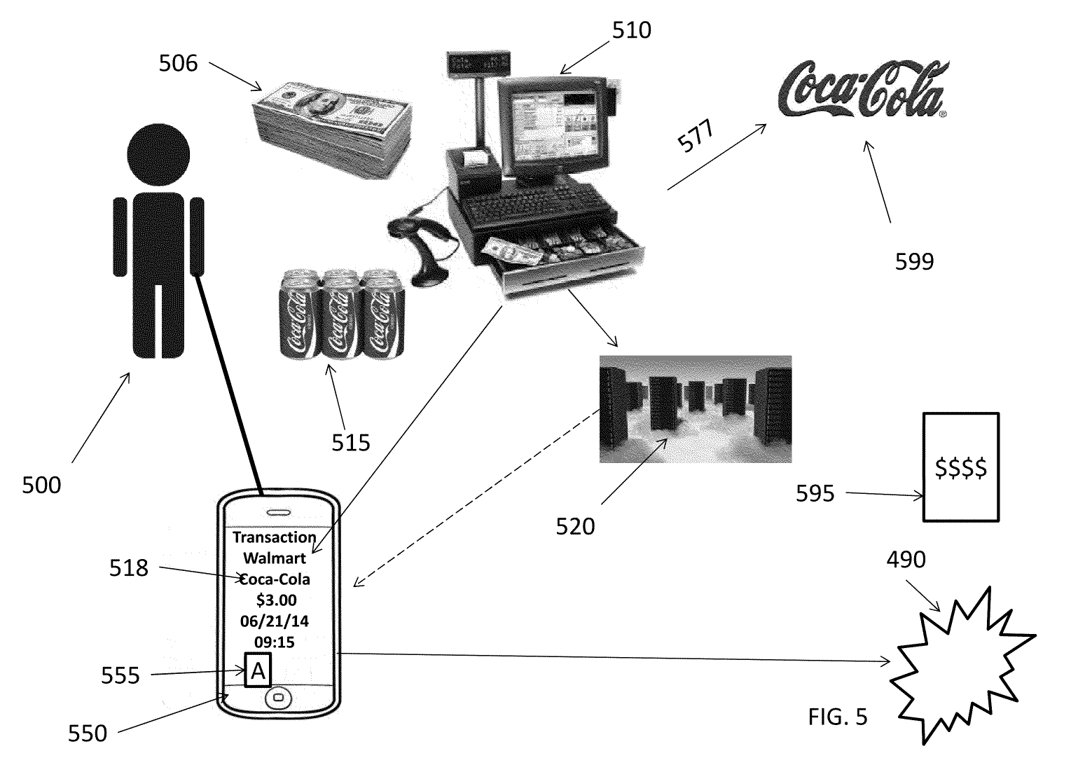

FIG. 5 shows a similar arrangement as shown in FIG. 4, except where the receipt 518 is virtual and sent wirelessly directly from the cash register 510 or related server 520 to the smartphone 550, where purchase details may be displayed. In this embodiment, the cash register 510 may be further adapted to send details of the purchase, including details identifying the user 500 to a third party vendor 599, whose product 515 may have been purchased or may be associated with a coupon 595. Sending of this information may require approval of user 500 and may allow user to receive coupons from the third party vendor 599 and/or the store where the purchase of product 515 was made. The vendor 599 receives 577 real-time data as to the sale of its product 515. An application 555 may be included with the smartphone 550 to allow for organizing and analyzing purchase data as that provided by the virtual receipt 518. Data may optionally be sent by the cash register 510 to a network 520 for long-term or short-term storage by a store associated with cash register 510. Note that the instant embodiment may be applied to cash 506 or other non-credit card payments. The smartphone 550 may be adapted to send purchase details to a personal storage network 590 for long-term storage and/or analysis.

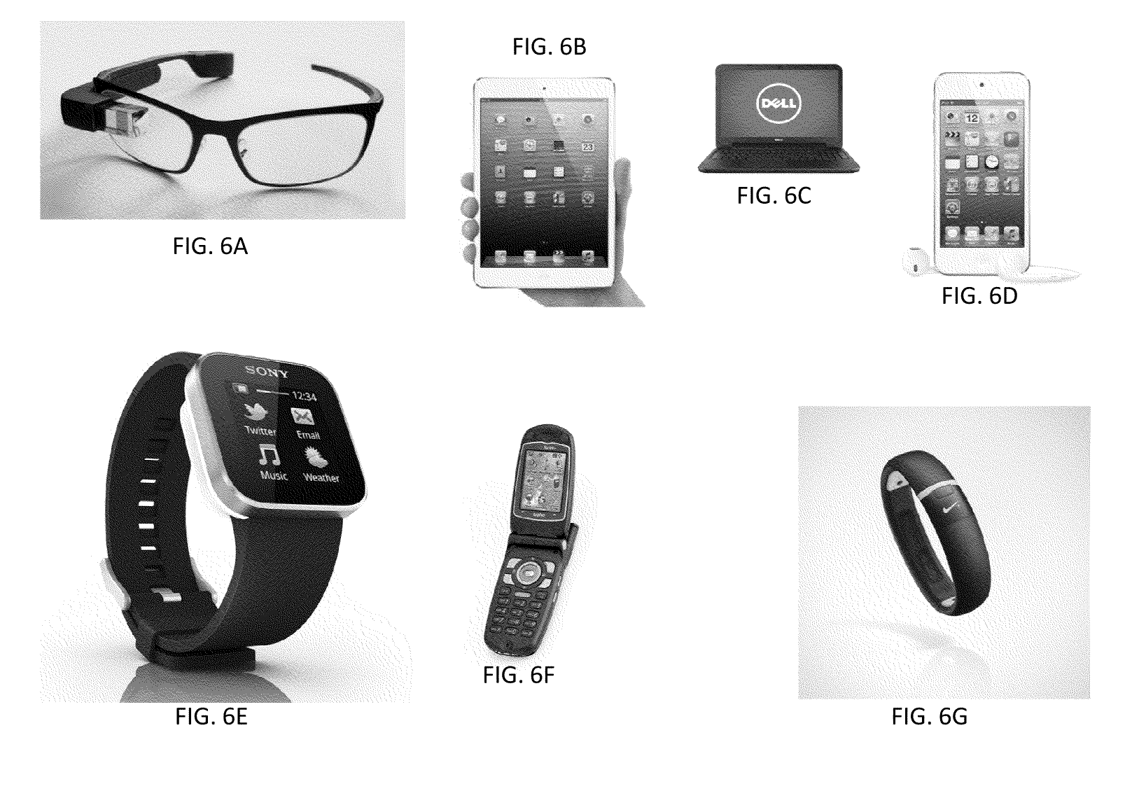

Attention is sent to FIG. 6A. A mobile computing device has been described primarily as a smartphone in previous embodiments. Yet, other elements such as Google Glass (FIG. 6A), tablet computer (FIG. 6B), laptop computer (FIG. 6C), mobile electronic device like an iPod Touch (FIG. 6D), smart watch (FIG. 6E), cellular phone (FIG. 6F), or wearable electronic device (FIG. 6G) or the like may fulfill the role of mobile computing device.

### Third Embodiment

The invention additionally includes a device for allowing access to details of a purchase, including: a cash register; a wireless communication module associated with the cash register; and, a mobile computing device adapted to receive information from the cash register via said wireless communication module.

In one aspect of the device, the wireless communication module is realized as wired or wireless communication between a cash register and a computing device via a cellular network, WiFi, IR, Bluetooth, RF, RFID, NFC, SMS, MMS, IP Push, sound signals or communication over application API.

In another aspect of the device, the information may include any of the following: date of purchase, time of purchase, location of purchase, cash register number, last four digits of credit card if employed in payment, amount paid, items purchased, unit price per item, number of each item purchased, any discounts for any of said items, and any coupons employed in said purchase.

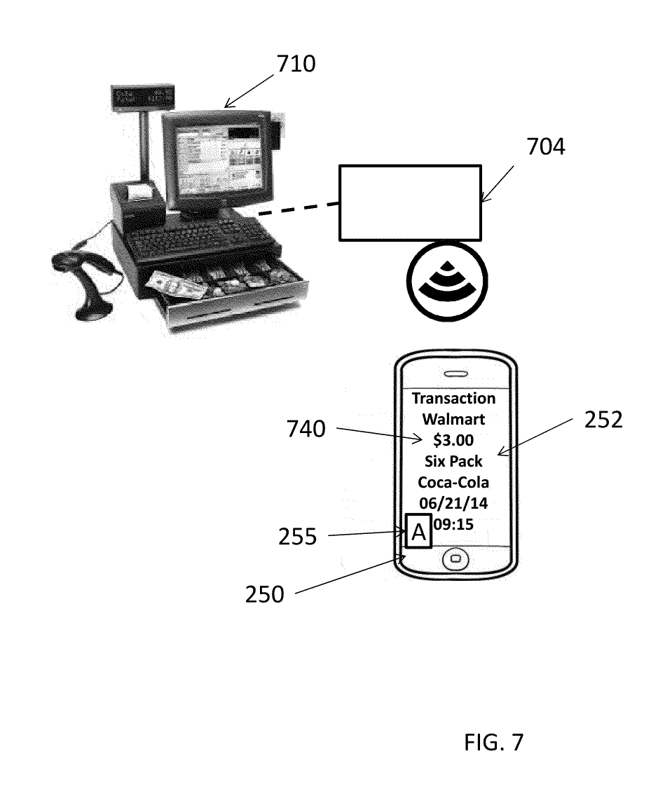

Attention is turned to FIG. 7. FIG. 7 includes a cash register 710 in communication with a wireless communication module 704. The wireless communication module 704 may be an integral part of the cash register 710 or may be realized as a separate element. The module 704 may communicate with the cash register 710 via wired or wireless means. The module 704 is adapted to receive information from the cash register 710. The information may include date, time, cash register 710 number, clerk identifier, as well as details of any purchase including but not limited to services or goods purchased, total cost, unit costs, payment method details, and possibly a customer identifier. The module 704 is further adapted to wirelessly send 707 said information or a portion thereof to a smartphone 750 or other mobile computing device. Module 704 sends information regarding a purchase to a smartphone 750 or other mobile computing device in a manner that only said smartphone or other mobile computing device is adapted to successfully receive and interpret information sent from the module 704. Wireless sending modalities include but are not limited to WiFi, Bluetooth, IR, SMS, IM, Skype, phone call, and email. The information sent from the module 704 may be coded; it may be coded in such a manner that only a smartphone 750 or other mobile computing device specifically identifiable as belonging to the person who performed the transaction in question is adapted to receive and successfully interpret the information. An app 755 may be required for receiving the information from the module and interpreting said information. A smartphone 750 or similar device may include a user interface that may be realized as a graphical user interface 752 for displaying purchase data 740 associated with a purchase made with the cash register 710 and wirelessly sent to the smartphone 750 via the module 704.

### Fourth Embodiment

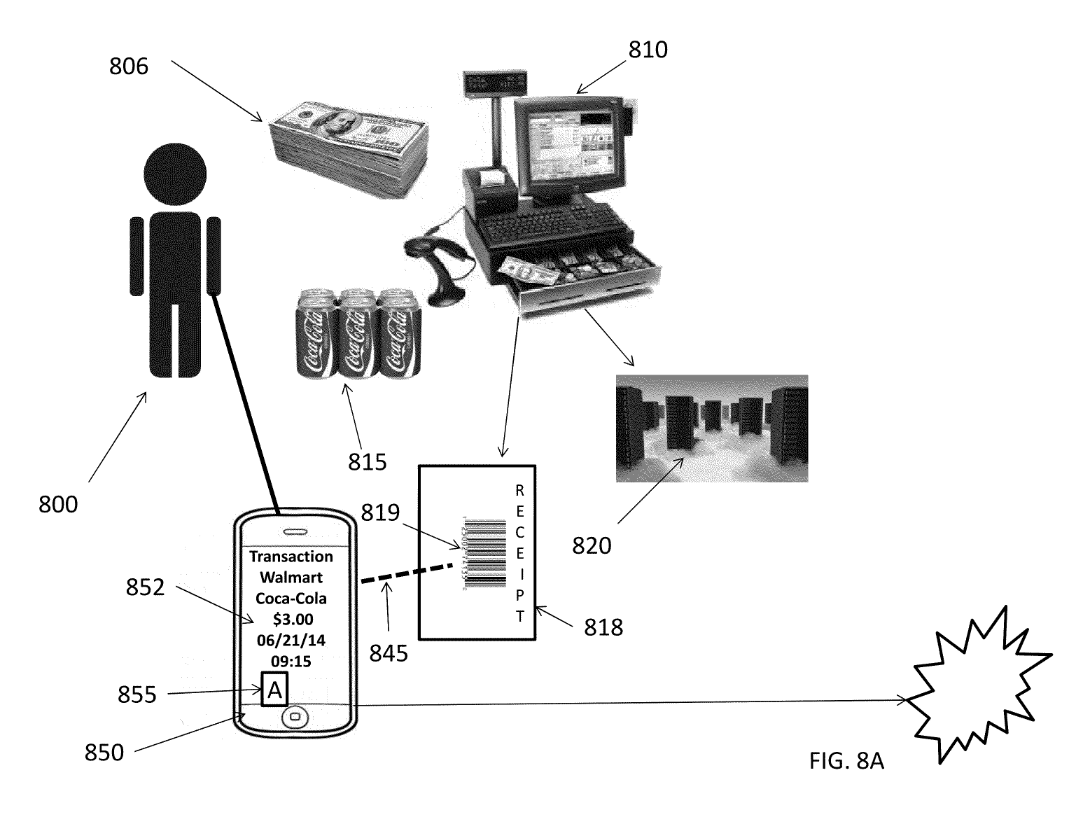

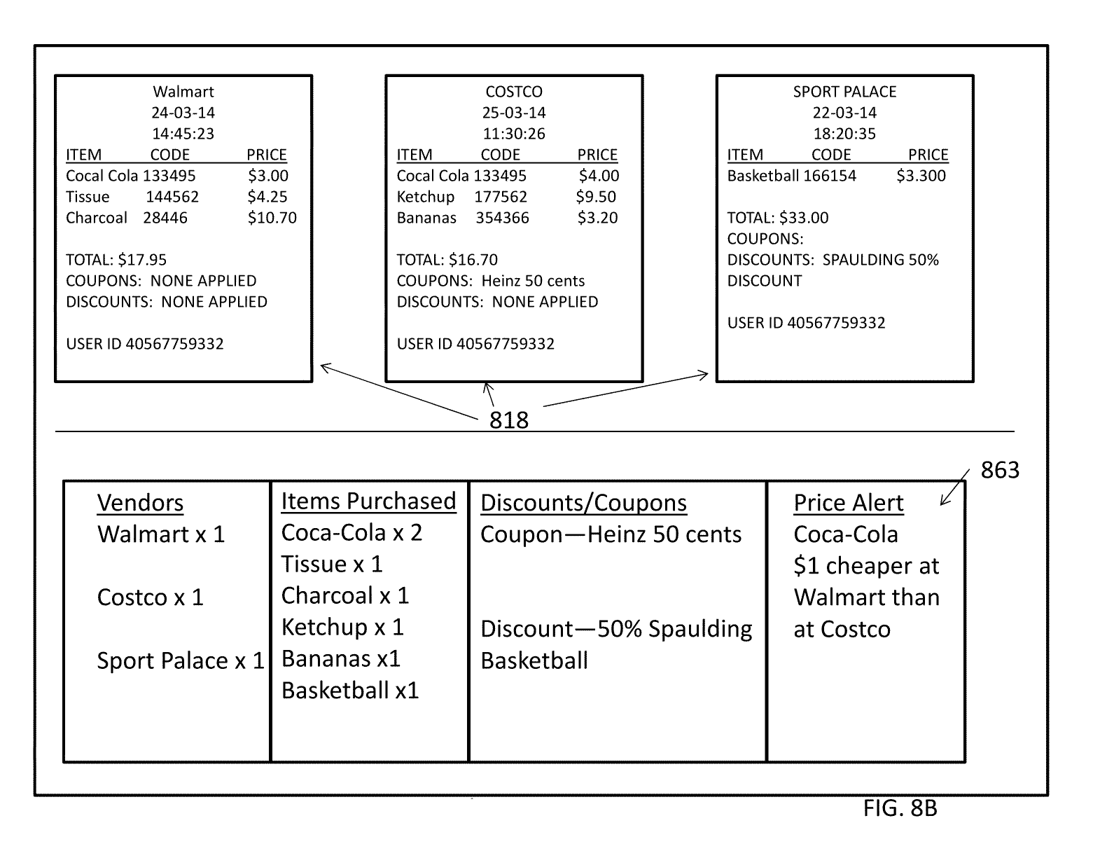

Attention is turned to FIG. 8. A user 800 makes a purchase of a service or item 815 and pays with cash 806 or other payment instrument such as PayPal, check, wire transfer or the like. The cash register 810 handling the transaction produces a physical receipt 818 which includes a barcode 819 adapted to be read by user 800 smartphone 850 only (the user 800 having given his/her telephone number to a clerk at the cash register 810, or alternatively, the transaction includes the smartphone 850 telephone number data). The smartphone 850 scans 845 the barcode 819 on the receipt 818, and on the smartphone 850 graphical user display 852 optionally appears details of the purchase: what service or item 815 was purchased, how much money 806 was tendered and how much change was given. Additional details such as date and time, cash register 810 number and clerk identifier may also be provided. Details (data) of the purchase may be retried directly from the receipt 818 via the barcode 819, or through the cash register 810 or an associated network 820, again via the barcode 819 that is only accessible via the user's smartphone 850. The data associated with the purchase of the item 815 may be combined and/or compared with other purchases to allow user 800 to keep accurate track of her purchases and how her money 806 is used. An application 855 may be included with the smartphone 850 to allow for organizing and analyzing purchase data as that provided by the scanned receipt 818. Data may optionally be sent by the smartphone 850 to a memory storage device, computer or network 890 for long-term or short-term storage.

Attention is turned to FIG. 8B. The top part of the figure shows three unique receipts 818 entered into the smartphone as described above. The receipts include data such as date, time of purchase, items purchased, price for each item, coupons/discounts and user identification number that allows user's smartphone to scan the barcode of the receipts. The bottom part of FIG. 8B shows one arrangement of the data which have been collected from the three receipts: vendors, items purchase, discounts/coupons and price alerts. It is understood that there is a near infinite number of ways to arrange and further analyze data (by day, but location, by price range, etc.). The chart 863 could include data for a plurality of credit cards owned by a single person or a group of related people, such as members of a single family or workers for a single company. The chart 863 might also include data for check, cash, and other purchases. It is understood that the plurality of receipts 818 may be generated by a single credit card, a plurality of credit cards, and in the latter case said plurality may belong to a single individual, a plurality of individuals, a family, a company, or a related group of people. Thus, the instant embodiment allows for all purchases from a single family to appear in a single chart 863 or spreadsheet.

As seen in the instant example, by moving receipt data from paper to digital, one may further arrange, analyze, and use specific buying data related to a plurality of purchases made by credit card(s) and/or other payment means.

It is understood that a cash register may be adapted to instruct an associated server or the like to send data directly to a user's smartphone or similar device. Alternatively or additionally, a cash register and/or an associated server, network or cloud network could send information directly to a user's memory storage device (FIG. 8, 890) without any recourse to smartphone or the like. It is further understood that in all embodiments, transactional data may be pushed by a cash register, associated server or the like, or said transactional data may be pulled by a user's smartphone, memory storage device, or the like. All possible methods for moving data relating to a purchase between a provider of a good or service and the purchaser of the same may be included in the instant invention, including any intermediary devices or elements between a cash register and a server, or a smartphone and a memory storage device.

It is expected that during the life of a patent maturing from this application, additional systems for providing improved manipulation of credit card and other purchase data will be developed, and the scope of the term of the invention is intended to include all such new technologies a priori.

### Fifth Embodiment

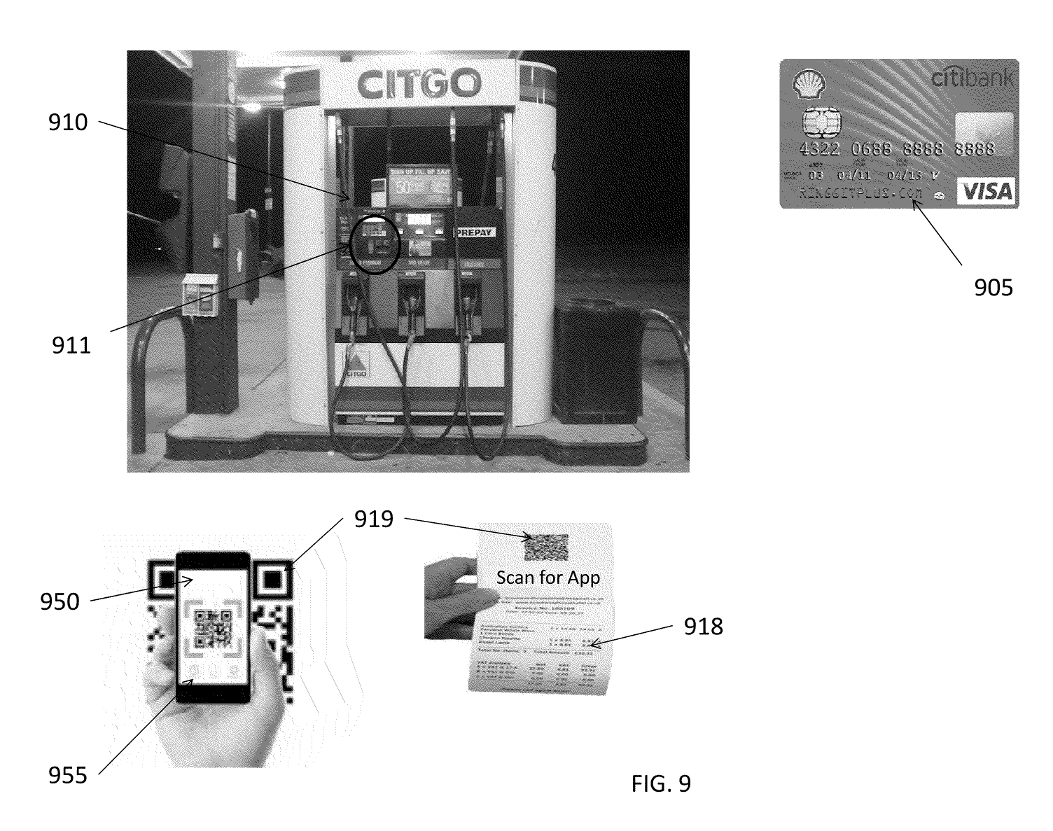

In the instant embodiment, preset rules may allow for disallowing and/or reporting a forbidden or restricted transaction. Attention is turned to FIG. 9. A user (not shown) has a debit card 905 adapted to be placed in a dedicated reader 911 of a cash register 910 associated with a gas pump. User buys gas and receives a paper receipt 918 that includes a code 919 adapted to be scanned by a smartphone 950 or similar mobile computing device. Scanning of code 919 may lead to smartphone 950 recording of details related to purchase and/or access to memory of the cash register 910 or an associated data network 920 to receive details regarding the purchase. User pays, scans QR code 919, application 955 on smartphone 950 receives card 905 transaction details directly from the QR code 919 (no additional communication with cash register 910 or other element is needed, for example), application 955 realizes that transaction disobeys a certain predetermined rule associated with the card 905 (an 18 year old is not allowed to buy gas, as determined by his parents) and reports to card 905 owner and/or card 905 authorized manager (employee manager, head of family etc.) as per relevant pre-established rules, also to card vendor/provider (not shown) as a possible fraud to be checked.

At end of period (month, year, etc.), or by request, user may get a report of all card 905 rules violations, in case of a user managing other individuals or groups (e.g. head of family, company expenses manager etc.) card 905 rules violations may be presented per user (e.g. employee, family member). Vendor may revoke or suspend card 905 or certain transactions that are forbidden with the provided debit card 905. A rule violation may be also involve not scanning a receipt 918 code 919 for a certain transaction, as revealed at end of period, so as to provide a motivation for the card holder (e.g. 18 years old, employee holding company credit card etc.) to always scan the code 919 for all transactions. Application 955 may also add scoring for the usage of the credit card by the credit card holder, according to the pre-set rules, as a tool for the authorized card monitoring person (such as head of family, company expenditure officer etc.), score can be categorized to red, yellow, green, with alerts to the authorized card monitoring person on red scoring.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized cases as herewith described. The instant invention may be employed for fixed location cases or other arrangements not directly described herewith.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. In some embodiments, a credit card may be realized as a digital wallet or similar payment system.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A device for allowing access to details of a purchase, including:
at least one cash register adapted to store details of a purchase;
a receipt generated by said cash register for said purchase, said receipt adapted to include a code identifying said purchase; and,
a mobile computing device with a graphical user interface adapted to scan said code and access some or all of said details related to said purchase.

2. The device according to claim 1, wherein said cash register is realized as a plurality of cash registers and said purchase is realized as a plurality of purchases.

3. The device according to claim 1, wherein said mobile computing device is realized as a smartphone, a cellular phone, a tablet computer, a wearable computing device, a watch computing device, Google Glass, a laptop computer, or a mobile electronic device.

4. The device according to claim 1, wherein said details include date of purchase, time of purchase, location of purchase, cash register number, last four digits of credit/debit card if employed in payment, amount paid, items purchased, unit price per item, number of each item purchased, any discounts for any of said items, and any coupons employed in said purchase.

5. The device according to claim 1, wherein said cash register is further adapted to send said details of said purchase to a at least one predetermined server.

6. The device according to claim 5, wherein said code allows access of said details of said purchase on said at least one predetermined server.

7. The device according to claim 1, wherein said receipt is realized as a digital receipt adapted to be sent wirelessly from said cash register to said mobile computing device.

8. The device according to claim 4, wherein said details are accessible to producers of said items purchased.

9. A method for providing digital details of a purchase to a consumer, including:
providing a cash register adapted to send predetermined details relating to a purchase to at least one predetermined server;
performing a check-out with said cash register, wherein a consumer pays at said cash register for at least one item that he/she has purchased;
sending details of said purchase to said at least one predetermined server;
providing said consumer with a paper receipt of said purchase, said receipt including at least one code adapted to allow said consumer access to said details of said purchase from said at least one predetermined server;
scanning said code on said receipt with a mobile computing device;
accessing said details of said purchase on said mobile computing device; and,
displaying on a graphical user interface associated with said mobile computing device said details of said purchase.

10. The method according to claim 9, wherein said at least one server is associated with a cloud-based computing system.

11. The method according to claim 9, wherein said at least one server is associated with a client-server network.

12. The method according to claim 9, further including the step of sending said details wirelessly from said cash register to said mobile computing device.

13. The method according to claim 9, wherein said checkout involves payment with a credit/debit card.

14. The method according to claim 9, wherein said details include date of purchase, time of purchase, location of purchase, cash register number, last four digits of credit card if employed in payment, amount paid, items purchased, unit price per item, number of each item purchased, any discounts for any of said items, and any coupons employed in said purchase.

15. The method according to claim 14, wherein said details further include a warranty for at least one item purchased.

16. The method according to claim 14, further including the step of sending said details to at least one third party.

17. The method according to claim 16, wherein said at least one third party is a manufacturer of at least one item involved in said purchase.

18. A device for allowing access to details of a purchase, including:
a cash register;
a wireless communication module associated with said cash register; and,
a mobile computing device adapted to receive information from said cash register via said wireless communication module.

19. The device according to claim 18, wherein said wireless communication module is realized as a cellular network, WiFi, IR, Bluetooth, RF, RFID, NFC, SMS, MMS, IP Push, sound signals or communication over application API.

20. The device according to claim 18, wherein said information may include any of the following: date of purchase, time of purchase, location of purchase, cash register number, last four digits of credit card if employed in payment, amount paid, items purchased, unit price per item, number of each item purchased, any discounts for any of said items, and any coupons employed in said purchase.
